(19) United States
(12) Patent Application Publication
(10) Pub. No.: US 2026/0338261 A1
(43) Pub. Date: Oct. 29, 2026

(54) Power Transmission Apparatus

(71) Applicant: Hector Acevedo, Calgary (CA)

(72) Inventor: Hector Acevedo, Calgary (CA)

(21) Appl. No.: 19/658,588

(22) Filed: Apr. 26, 2026

Related U.S. Application Data
(60) Provisional application No. 63/794,878, filed on Apr. 25, 2025.

(51) Int. Cl. F16H 7/06; F16H 7/18

(52) U.S. Cl. CPC F16H 7/06; F16H 7/18

(57) ABSTRACT

A power transmission apparatus comprising one or more input toothed wheels, a drive shaft, a plurality of mechanical power transmission elements adapted to allow rotation in only one direction, the necessary configuration to apply a system of multiple external linear forces uniformly and perpendicularly to the drive shaft to establish the torque input, and the necessary arrangements to provide a rotational speed input to the drive shaft to establish the speed input. The toothed wheels are solidly integrated to the drive shaft which is configured to accept the perpendicular external forces so as to exert a twisting force effect on the toothed wheels which in turn transfer the torque to the drive shaft. This mechanical transmission arrangement to harness torque and speed inputs greatly maximizes the amount of power transferred from the sources of power.

### BACKGROUND/SUMMARY

### Technical Field

The present invention relates to power transmission apparatuses and the efficiency to harness the speed and torque inputs provided by the sources of mechanical power.

### Background

Power transmission apparatuses are used to transmit mechanical rotational energy from a source of rotational power to the output power shaft of the transmission apparatus performing the work. However, there are inefficiencies to effectively transfer the mechanical rotational energy to get the most of the sources of power.

Accordingly, it is desirable to provide a power transmission apparatus with the ability to efficiently harness the power given by the sources of mechanical rotational energy maximizing the amount of power transferred.

### SUMMARY

In the view of the problem described above, it is one objective of the invention to provide a power transmission apparatus capable of addressing the problem mentioned above.

To achieve the above objective, in accordance with one example embodiment of the invention, provided is a power transmission apparatus, comprising a plurality of input toothed wheels solidly integrated to a drive shaft, a plurality of one-way mechanical power transmission drives (configured to allow rotation in only one direction), a plurality of external linear actuators to exert force and to drive the drive shaft back and forth in a reciprocating fashion, producing torque on the toothed wheels, which in turn is transmitted to the drive shaft. The power transmission apparatus also includes a plurality of rectilinear translational guides and a source of mechanical rotational power to provide an input speed.

This example embodiment of the present disclosure is directed to a power transmission apparatus capable of harnessing the input torque provided by external linear forces, and the input speed provided by a rotational power source, in order to maximize the amount of power transferred from the source of power.

It is understood that the summary above is provided to introduce a simplified concept of the present disclosure which will be fully described in the detailed description. It should also be understood that the phraseology and terminology used herein to describe the orientation, direction, and location are for the purpose of description and clarity of the example embodiment and should not be regarded as limiting, since various changes, modifications, and configurations may be achieved without departing from the spirit and scope of the concepts of this invention.

In order to make the description, features, and advantages of this example embodiment more apparent and easier to understand, the aforementioned plurality of input toothed wheels may be wheel sprockets; the plurality of mechanical power transmission drives may be chain drive transmissions; the plurality of external linear actuators to exert linear forces may be linear hydraulic actuators; the plurality of rectilinear translational guides may be U-shaped guide rigid structures; and the mechanical rotational power sources may be electric motors.

### DESCRIPTION

### BRIEF DESCRIPTION OF THE DRAWINGS

The drawings described herein are for illustrative purposes only.

FIG. 1 is a front view depicting the wheel sprockets in permanent meshing engagement with the chain drives arranged on the left and right of the drive shaft. It also shows the U-shape rigid guide structures (rectilinear guide devices).

FIG. 2 illustrates each wheel sprocket with its respective meshing chain drive disposed along the left side of the drive shaft. (The chains are cut off, so that the sprockets and the other components are more clearly visible.)

FIG. 3 illustrates each wheel sprocket with its respective meshing chain drive disposed along the right side of the drive shaft. (The chains are cut off, so that the sprockets and the other components are more clearly visible.)

### DETAILED DESCRIPTION

An embodiment of the present invention is described below by way of example only, which illustrates a way of putting the invention into practice with the intention of making this easier to understand, an embodiment having the aforementioned rectilinear translational guides and the mechanical power transmission drives, arranged in vertical orientation and parallel to each other, has been chosen as a preferred embodiment. Therefore, the use of the directional terms ‘up,’ ‘down,’ ‘vertical,’ ‘horizontal,’ ‘top,’ ‘bottom,’‘left,’and ‘right’are apparent and appropriate.

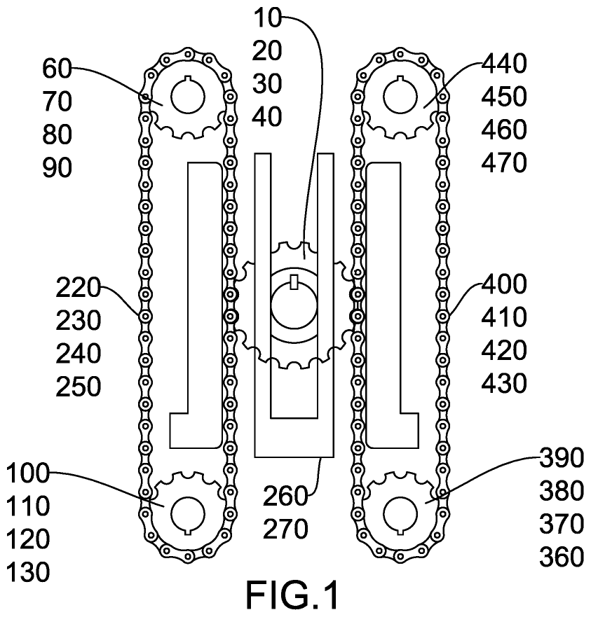

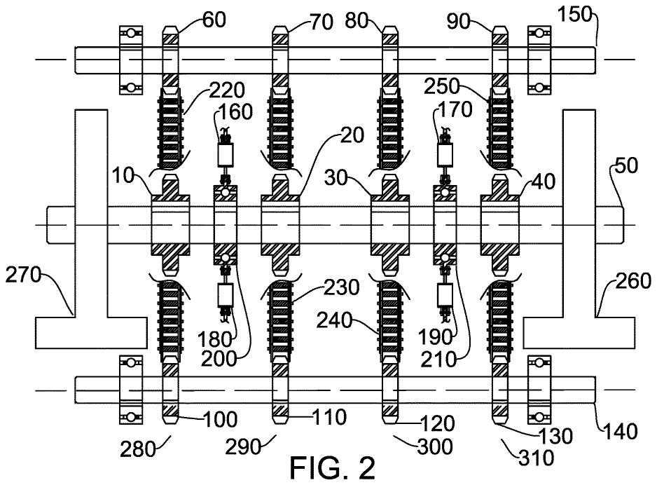

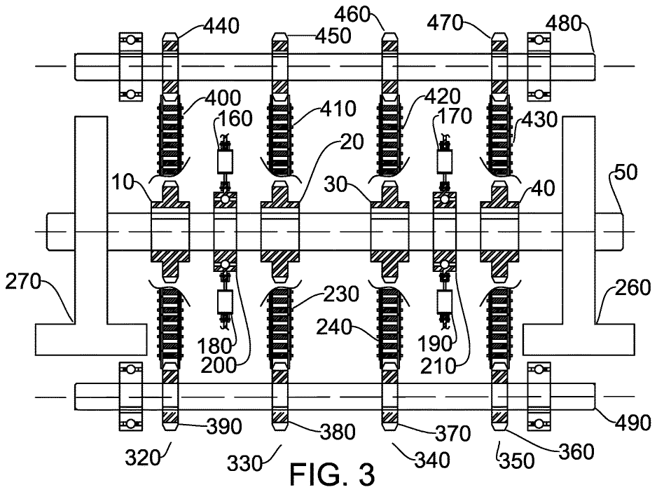

As shown in FIG. 1, FIG. 2, and FIG. 3 the power transmission apparatus is comprised of a plurality of input toothed wheels (10, 20, 30, 40); a drive shaft 50; a plurality of one-way mechanical power transmission drives (adapted to allow rotation in one direction only) 280,290, 300, 310, 320, 330, 340, 350; a plurality of external linear actuators 160, 170, 180, 190 to propel the drive shaft transversely back and forth in a reciprocating motion; a plurality of bearing housing assemblies 200, 210 adapted to be connected mechanically to the linear actuators; a mechanical rotational power source (not shown) connected to the drive shaft 50 to provide it with an input speed; and a plurality of rectilinear translational guides 260, 270.

As stated in the summary above, in order to make this description more apparent and easier to understand, henceforth for this example embodiment the aforementioned plurality of input toothed wheels will be referred to as wheel sprockets 10, 20, 30, 40; the plurality of one-way power transmission drives will be referred to as one-way chain drives 280, 290, 300, 310, 320, 330, 340, 350; the plurality of external linear actuators to exert linear forces will be referred to as hydraulic actuators 160, 170, 180, 190; the plurality of rectilinear translational guides will be referred to as guide rigid structures 260, 270; and the mechanical rotational power source (not shown) will be referred as electric motor.

As shown in FIG. 2, the one-way chain drives 280, 290, 300, and 310 are disposed on the left side of the drive shaft 50, wherein the chain drive 280 is composed of the sprockets 60 and 100 and the chain 220; the chain drive 290 is composed of the sprockets 70 and 110 and the chain 230; the chain drive 300 is composed of the sprockets 80 and 120 and the chain 240; the chain drive 310 is composed of the sprockets 90 and 130 and the chain 250.

The sprockets 60, 70, 80, 90 are solidly integrated to the rotating shaft 150 by means of a shaft locking device. The sprockets 100, 110, 120, 130 are solidly integrated to the rotating shaft 140 by means of a shaft locking device.

With reference to FIG. 1 and FIG. 2, the sprockets 10, 20, 30, and 40, are in permanent meshing engagement as to transmit power with the chains 220, 230, 240, and 250 respectively, on the left side of the drive shaft 50.

As shown in FIG. 3, the one-way chain drives 320, 330, 340, 350, are disposed on the right side of the drive shaft 50, wherein the chain drive 320 is composed of the sprockets 390, 440 and the chain 400; The chain drive 330 is composed of the sprockets 380, 450 and the chain 410; The chain drive 340 is composed of the sprockets 370, 460 and the chain 420; And the chain drive 350 is composed of the sprockets 360, 470 and the chain 430.

The sprockets 440, 450, 460, and 470 are solidly integrated to the rotating shaft 480 by means of a shaft locking device.

The sprockets 360, 370, 380, and 390 are solidly integrated to the rotating shaft 490 by means of a shaft locking device.

With reference to FIG. 1 and FIG. 3, the wheel sprockets 10, 20, 30, and 40 are in permanent meshing engagement as to transmit power with the chains 400, 410, 420, and 430 respectively, on the right side of the drive shaft 50.

The rotating shafts 140, 150, 480, and 490 are secured to the frame (not shown) with a pair of one-way bearings mounted at each end of them, so that, the rotating shaft 150 and the sprockets 60, 70, 80, 90, firmly secured to it, will only rotate in a preselected direction; The rotating shaft 140 and the sprockets 100, 110, 120, 130, firmly secured to it, will only rotate in a preselected direction; The rotating shaft 480 and the sprockets 440, 450, 460, 470, firmly secured to it, will only rotate in a preselected direction; And the rotating shaft 490 and the sprockets 360, 370, 380, 390, firmly secured to it, will only rotate in a preselected direction.

This arrangement configures each of the aforementioned chain drives 280, 290, 300, 310, 320, 330, 340, 350, to allow rotation in the selected direction only but locks up and prevents rotation in the opposite direction.

FIG. 2 and FIG. 3 show the bearing housing assemblies 200 and 210, which are rotatably mounted on the drive shaft 50 and uniformly disposed along its axis in order to spread the vertical loads equally. Each bearing housing assembly, 200, 210 is provided with a rotatable pin (not shown) at the top of the housing, and another one (not shown) at the bottom, to pivotally attach the linear hydraulic actuators 160, 170, 180, 190 to them, so that the most effective force component transferred from the hydraulic actuators 160, 170, 180, 190, to the drive shaft 50, is the vertical component.

As shown in FIG. 2 and FIG. 3, the extending end of the linear hydraulic actuators 160 and 170 are pivotally connected to the pins (not shown) at the top of the bearing housing assemblies 200 and 210 respectively; The extending end of the linear hydraulic actuators 180 and 190 are pivotally attach to the pins (not shown) at the bottom of the bearing housing assemblies 200 and 210 respectively; And the non-extending end of the aforementioned linear hydraulic actuators 160, 170, 180, 190 are pivotally attached to the base frame (not shown) of the machine.

The rigid guide structures 260, 270 as shown in FIGS. 1, 2 and 3, are placed along the drive shaft 50 and are comprised of two parallel bars, diametrically opposed, facing one another and solidly attached to the base frame (not shown) forming a U-shaped configuration placed with the drive shaft 50 therebetween. The rigid guide structures 260, 270 assure that the drive shaft 50 will follow a rectilinear motion as it is driven up and down by the linear hydraulic actuators 160, 170, 180, and 190.

The drive shaft 50, as depicted in FIG. 2 and FIG. 3 is in permanent slidably contact with the rigid guide structures 260, 270 and is continuously driven up and down, resembling a reciprocating cycle, by the action of sequentially synchronized push and pull forces exerted by the linear hydraulic actuators 160, 170, 180, and 190. The drive shaft 50 is vertically supported by said linear hydraulic actuators 160, 170, 180, 190, while the rigid guide structures 260, 270, prevent it from moving in the axis direction and/or horizontally.

The wheel sprockets 10, 20, 30, 40 are solidly coupled to the drive shaft 50 by means of shaft locking devices, forming an integrated unit that rotates and move up and down as a whole.

The bearing housing assemblies 200, 210 are rotatably mounted on the drive shaft 50, so that, when an input torque is given to the wheel sprockets 10, 20, 30, 40, the whole assembly, wheel sprockets and drive shaft 50 will freely rotate on the bearing housing assemblies 200, 210, accordingly with the direction of the given input torque.

With reference to FIGS. 1, 2 and 3, when the electric motor (not shown) simultaneously provides mechanical rotational power to the rotating shafts 140, and 490 in a predetermined direction of rotation (either clockwise or anticlockwise), And all the one-way chain drives 280, 290, 300, 310, 320, 330, 340 and 350 have been preset to follow the direction of rotation of the electrical motor, all the aforementioned one-way chain drives will rotate in the same direction (the predetermined direction) as the electrical motor (not shown). And in turn, said one-way chain drives 280, 290, 300, 310, 320, 330, 340 and 350 will cause the wheel sprockets 10, 20, 30, 40, and the drive shaft 50, to turn in the opposite direction (opposite to the predetermined direction), which is an intentionally expected direction. The magnitude of the speed provided to the drive shaft 50 by the electric motor (not shown), establishes the input speed to the power transmission apparatus that is being described in this example embodiment.

As seen in FIGS. 1, 2, and 3, the drive shaft 50 is disposed so that the one-way chain drives 280 and 320 are simultaneously in permanent meshing engagement with the wheel sprocket 10; The one-way chain drives 290 and 330 are simultaneously in permanent meshing engagement with the wheel sprocket 20; The one-way chain drives 300 and 340 are simultaneously in permanent meshing engagement with the wheel sprocket 30; And the one-way chain drives 310 and 350 are simultaneously in permanent meshing engagement with the wheel sprocket 40.

The linear hydraulic actuators 160, 170, 180, and 190, are configured to automatically move in a predetermined sequence so as to operate in a reciprocating cycle (motion), where the push and pull forces are always adding up to each other regardless of the direction in which they are actuating. According with FIGS. 2 and 3, during the upstroke, the hydraulic actuators 180 and 190 are pushing upwards, and the hydraulic actuators 160 and 170 are pulling upwards. Conversely, during the downstroke the actuators 160 and 170 are pushing down and the actuators 180 and 190 are pulling downwards.

All the one-way chain drives 280, 290, 300, 310 on the left, and 320, 330, 340, 350 on the right of the drive shaft 50, are to be set to rotate in the same predetermined direction of rotation of the aforementioned electrical motor (not shown), which is mechanically connected as to transmit its rotational power to the rotating shafts 140 and 490.

In reference to FIGS. 1, 2, 3 and as first case scenario, when the predetermined direction of rotation of all one-way chain drives 280, 290, 300, 310, 320, 330, 340, and 350, is set to be the anticlockwise direction, the chain links of the chains 400, 410, 420, 430, that are in meshing engagement with the teeth of the wheel sprockets 10,20, 30, and 40, are allowed to move downwards in linear motion, but they will be locked in the opposite direction (upward direction). Therefore, when the drive shaft 50 is being driven by the hydraulic actuators 160, 170, 180, 190, in the upward direction, said chain links will be locked up and will act as pivot points, subjecting the wheel sprockets 10, 20, 30, and 40 to a turning effect (torque) in the clockwise direction, for as long as the vertical forces exerted by the hydraulic actuators 160, 170, 180, and 190 are acting in the up direction.

On the other hand, the chain links of the chains 220, 230, 240, 250 that are in meshing engagement with the teeth of the wheel sprockets 10, 20, 30, and 40, are allowed to move upwards in linear motion, but they will be locked in the opposite direction (downward direction). Therefore, when the drive shaft 50 is being driven by the hydraulic actuators 160, 170, 180, and 190 in the upward direction, said chain links will be moved upwards along with the sprocket's teeth, without offering resistance to the motion, and without opposing the aforementioned turning effect in the clockwise direction, on the wheel sprockets 10,20, 30, and 40.

Now, with reference to FIGS. 1, 2 and 3, when the drive shaft 50 is being driven by the hydraulic actuators 160, 170, 180, 190 in the downward direction, the chain links of the chains 220, 230, 240, and 250, that are in meshing engagement with the teeth of the wheel sprockets 10, 20, 30, and 40, will act as pivot points, since they are prevented from moving in the downward direction, subjecting the wheel sprockets 10, 20, 30, and 40 to a turning effect (torque) in the clockwise direction.

On the other hand, the chain links of the chains 400, 410, 420, 430 that are in meshing engagement with the teeth of the wheel sprockets 10, 20, 30 and 40 will be moved down along with the sprocket's teeth, since they are not prevented from moving downwards, without opposing the aforementioned turning effect (torque) in the clockwise direction on the wheel sprockets 10, 20, 30, and 40.

As seen from this first case scenario, when the predetermined direction of rotation of all one-way chain drives 280, 290, 300, 310, 320, 330, 340, 350, is the anticlockwise direction, the direction of rotation of the wheel sprockets 10, 20, 30, 40 and consequently of he drive shaft 50, will always be in the clockwise direction, regardless of the direction in which the drive shaft 50 is being driven, up or down, by the forces exerted by the hydraulic actuators 160, 170, 180, and 190.

With reference to FIGS. 1, 2 and 3, as a second case scenario, when the predetermined direction of rotation of all one-way chain drives 280, 290, 300, 310, 320, 330, 340, 350, is set to be the clockwise direction, the chain links of the chains 220, 230, 240, and 250, that are in meshing engagement with the teeth of the wheel sprockets 10, 20, 30, 40, are allowed to move downwards in linear motion, but they will be locked up in the opposite direction (upward direction). Therefore when the drive shaft is being driven by the hydraulic actuators 160, 170, 180, 190, in the upward direction, said chain links will be locked up and will act as pivot points, subjecting the wheel sprockets 10, 20, 30, 40, to a turning effect (torque) in the anticlockwise direction, for as long as the vertical forces exerted by the hydraulic actuators 160, 170, 180, and 190 are acting in the upward direction.

Now, the chain links of the chains 400, 410, 420, 430, that are in meshing engagement with the teeth of the wheel sprockets 10, 20, 30, and 40, are allowed to move upwards in linear motion, but they will be locked up in the opposite direction (downward direction). Therefore, when the drive shaft 50 is being driven by the hydraulic actuators 160, 170, 180, 190, in the upward direction, said chain links will be moved upwards along with the sprocket's teeth without offering resistance to the motion, and without opposing the aforementioned turning effect (torque) in the anticlockwise direction, on the wheel sprockets 10,20, 30, and 40.

With reference to FIGS. 1, 2 and 3, when the drive shaft 50 is being driven by the hydraulic actuators 160, 170, 180, 190 in the downward direction, the chain links of the chains 400, 410, 420, 430, that are in meshing engagement with the teeth of the wheel sprockets 10, 20, 30, and 40, will act as pivot points, since they are prevented from moving downwards, subjecting the wheel sprockets 10, 20, 30, and 40 to a turning effect (torque) in the anticlockwise direction.

On the other hand, the chain links of the chains 220, 230, 240, 250 that are in meshing engagement with the teeth of the wheel sprockets 10, 20, 30, 40, will move downwards along with the sprocket's teeth, since they are not prevented from moving downwards, without opposing the aforementioned turning effect (torque) in the anticlockwise direction, on the wheel sprockets 10, 20, 30, and 40.

As seen on this second scenario, when the predetermined direction of rotation of all one-way chain drives 280, 290, 300, 310, 320, 330, 340, 350, is set to be the clockwise direction, the direction of rotation of the wheel sprockets 10, 20, 30, 40 and the drive shaft 50, will always be in the anticlockwise direction, regardless of the direction in which the drive shaft 50 is being driven, up or down, by the forces exerted by the hydraulic actuators 160, 170, 180, and 190.

For this example embodiment, as mention above, an electric motor (not shown), provides mechanical rotational power to the rotating shafts 140 and 490, which in turn, transfer this power to the wheel sprockets 10, 20, 30, 40, and to the drive shaft 50. The rotational speed reached by the drive shaft 50 is essentially the same speed at which the torque is delivered by the power transmission apparatus, object of this invention.

For this example embodiment, as mention above, the vertical forces exerted by the linear hydraulic actuators 160, 170, 180, and 190 on the drive shaft 50, produce a turning effect (torque) on the wheel sprockets 10, 20, 30 and 40. This turning effect is the torque input delivered to the power transmission apparatus. The magnitude of this torque is given by the product of the total force exerted by said linear hydraulic actuators to the drive shaft 50 and the radius of the sprockets 10, 20, 30, 40.

The forces exerted by the linear hydraulic actuators 160, 170, 180, 190, involve a significant amount of mechanical advantage, this mechanical advantage outputs an enlarge force, which in turn, will produce an enlarged amount of torque. As mentioned above, the rotational speed reached by the drive shaft 50, is the speed at which said enlarged amount of torque is delivered. In other words, the power harnessed on the drive shaft 50 is given by the product of said enlarged torque and the rotational speed reached by the drive shaft 50.

1. A power transmission apparatus comprising:
At least one input toothed wheel; wherein the input toothed is rigidly integrated into a drive shaft; A plurality of one-way mechanical power transmission drives, the plurality of one-way mechanical power transmission drives configured to selectively being set to rotate in only one direction; A plurality of external linear force devices configured to propel the drive shaft transversely in a reciprocating motion so as to generate an augmented torque output; A plurality of rectilinear translational guides, the plurality of rectilinear translational guides configured to constraint the drive shaft to slide along between them in a rectilinear motion; And a source of mechanical rotational power, the source of mechanical rotational power mechanically connected to the power transmission apparatus configured to impart an input rotational speed to deliver the augmented torque.

2. The power transmission apparatus, according to claim 1, wherein the input toothed wheel is simultaneously in permanent meshing engagement with a couple of one-way mechanical power transmission drives, the one-way mechanical power transmission drives are placed diametrically opposed to one another and essentially contained within the same plane of the input toothed wheel.

3. The power transmission apparatus, according to claim 1, in which the plurality of one-way mechanical power transmission drives further comprises: A plurality of one-way clutch bearings, the one-way clutch bearings are mounted on rotating shafts, the rotating shafts are linked by endless chains wrapped around sprockets, the sprockets are solidly attached to the rotating shafts.

4. The power transmission apparatus, according to claim 1, in which the drive shaft further comprises: A plurality of bearing housing assemblies, the bearing housing assemblies are rotatably and uniformly mounted on the drive shaft.

5. The power transmission apparatus, according to claim 4, wherein the plurality of bearing housing assemblies further comprises lug joint provisions, the lug joint provisions are positioned on opposite sides of the bearing housing assemblies.

6. The power transmission apparatus, according to claim 1, in which the plurality of external linear force devices further comprises a plurality of external linear actuators equipped with clevis pin provisions, the clevis pin provisions are attached to both ends of the external linear actuators.

7. The power transmission apparatus, according to claim 6, wherein the plurality of external linear actuators are pivotally attached to the plurality of bearing housing assemblies, the external linear actuators exert a force on the drive shaft, the force exerted on the drive shaft is essentially parallel to the rectilinear translational guides.

8. The power transmission apparatus, according to 1, wherein the drive shaft is configured to be moved transversely in a reciprocating motion, the reciprocating motion is executed by a synchronized push and pull action of the external linear force devices.

9. The power transmission apparatus, according to claim 1, wherein the plurality of one-way power transmissions drives are configured to selectively being set to rotate in a predetermined direction, when the one-way power transmission drives are set to rotate in a predetermined direction (first direction), the external linear force devices will exert a turning effect (torque) on the drive shaft in the opposite direction (second direction), the drive shaft will continuously rotate in the opposite direction (second direction) regardless of the direction in which the external linear forces are acting.

10. The power transmission apparatus, according to claim 1, in which the source of mechanical rotational power further comprises an electric motor and a set of chain drives, the chain drives are connected to the power transmission apparatus as to transmit power to the drive shaft, the drive shaft will rotate to a determined speed, the determined rotational speed reached by the drive shaft is essentially the speed at which the torque is delivered, the speed reached by the drive shaft establishes the speed input.

11. The power transmission apparatus, according to claim 1, wherein the external linear force devices exert an augmented force on the drive shaft, the augmented force exerted on the drive shaft will produce a torque effect on the toothed wheels and in turn on the drive shaft, the torque effect on the drive shaft is an augmented torque developed by the augmented force, the augmented force is the output force of the external linear force devices, the external linear force devices are configured to provide a significant amount of mechanical advantage, the torque developed by the augmented force establishes the torque input.

12. The power transmission apparatus, according to claim 1, wherein the input speed at which the augmented torque may be delivered, establish the torque and speed inputs delivered to the power transmission apparatus in which the input torque and the input speed are transferred to the drive shaft through independent channels, the independent channels are configured such that a variation in one of the input parameters may not substantially affect the other one, whereby a change in speed or a change in torque leaves the other parameter essentially constant, and wherein the drive shaft output power is defined by the equation, power equals torque multiplied by rotational speed.
